(19) United States
(12) Patent Application Publication
(10) Pub. No.: US 2014/0186479 A1
(43) Pub. Date: Jul. 3, 2014

(54) INTERCHANGEABLE MOLDING DESIGNS

(71) Applicants: Michael Ayotte, Murray, UT (US); Andrew Walker, Sandy, UT (US)

(72) Inventors: Michael Ayotte, Murray, UT (US); Andrew Walker, Sandy, UT (US)

(21) Appl. No.: 13/733,479

(22) Filed: Jan. 3, 2013

(51) Int. Cl. B29C 33/30

(52) U.S. Cl. CPC B29C 33/306
USPC 425/195

(57) ABSTRACT

A molding member may include at least one interchangeable panel that may be interchanged after the molding member has been installed to a support structure. The molding member may allow the molding design to be replaced to match the desired appearance of the room in which the molding is attached. Thus, the molding design may be interchanged without having to remove and reinstall new molding members.

### FIELD

This disclosure relates generally to various types of molding adapted with insertable, interchangeable design panels that may be removed and replaced after the molding has been attached to a wall or other support structure.

### BACKGROUND

Base molding, trim molding, crown molding, or other types of molding are often installed only once during the life of a building. Once molding is installed, it is difficult to alter the molding design without removing the entire piece of molding. Although carpet or wall colors in a room may change, the molding typically remains the same design, unless the entire molding is removed and a new molding design is installed.

### BRIEF SUMMARY

It is desirable to have decorative molding with interchangeable panel designs so that when the various aspects, designs, or uses of a room change, design panels within the existing molding may be changed without having to replace the molding. In the installed position, the ends of the molding may not be accessible, which may preclude sliding a new design panel into position. However, the molding may be designed to allow the design panels to be removable from within the molding after the molding has been attached to a support structure without having to remove the molding from the support structure. Then ability to alter the design of the molding with interchangeable designs without reinstalling new molding members to a support structure may be advantageous in changing the overall decorative appearance of a room and molding pattern.

In one embodiment, a molding member may include a body member adapted to be attached to a structure such as a wall, ceiling, or floor. The body member may include a display cavity within the body member and defined by a back surface, a top surface, a bottom surface, a top retaining ledge, and a bottom retaining ledge. The body member may include a top recess defined by the top retaining ledge, the top surface, and a top portion of the back surface. The body member may include a bottom recess defined by the bottom retaining ledge, the bottom surface, and a bottom portion of the back surface. The body member may further include a compressible material attached to the back surface defining the display cavity. A removable design panel may be at least partially disposed between the top recess and the bottom recess within the display cavity. The removable design panel may be interchangeable from a front face of the body member after the body member is attached to the structure to which it is adapted to be attached to.

In another embodiment, a molding member may include a body member adapted to be attached to a structure such as a wall, ceiling, or floor. The body member may partially enclose a cavity. A cross-section of the cavity may be defined by a trapezoidal shape. A removable insert panel may be at least partially disposed within the cavity. The removable design insert may be interchangeable from within the cavity after the body member is attached to the structure to which the body member is adapted to be attached to.

In yet another embodiment, a molding member may include a body member defining a cavity. The cavity may be defined by a top surface, a top retaining ledge, a bottom retaining ledge, a bottom surface, and a back surface. The body member may include at least one removable panel at least partially disposed between the top surface and the bottom surface. The at least one removable panel may be removable after the body member is mounted to a support structure.

### BRIEF DESCRIPTION OF THE DRAWINGS

While the specification concludes with claims particularly pointing out and distinctly claiming what are regarded as embodiments of the disclosure, various features and advantages of this disclosure may be more readily ascertained from the following description of example embodiments provided with reference to the accompanying drawings, in which:

FIG. 1 is a schematic cross-section of one embodiment of a molding member adapted and configured to accept interchangeable panel members;

FIG. 2 is a cross-section of one embodiment of a design panel member;

FIG. 3 is a cross-section of one embodiment of a front panel member;

FIG. 4 is a schematic cross-section of one embodiment of a molding member;

FIG. 5a though 5e are depictions of the installation process of a design panel member and a front panel member;

FIG. 6 is a schematic cross-section of another embodiment of a molding member;

FIG. 7 is a schematic cross-section of an embodiment of a molding member including a top recess and a bottom recess, each partially defined by a curved surface;

FIG. 8 is a schematic cross-section of an embodiment of a molding member including an adhesive material;

FIG. 9 is a schematic of an elongated molding member; and

FIG. 10 is a schematic of a continuous molding design with an enclosed pattern.

### DETAILED DESCRIPTION

Disclosed herein is an improved molding design for easy installation and removal of various molding design insert panels without the need to remove the molding member. The molding disclosed herein may be installed and the design panels of the molding may be interchanged without removing the molding from the support structure to which it is attached. The molding may be useful as a crown molding, a window or door molding, base molding, or as a molding associated with a picture frame, painting, etc.

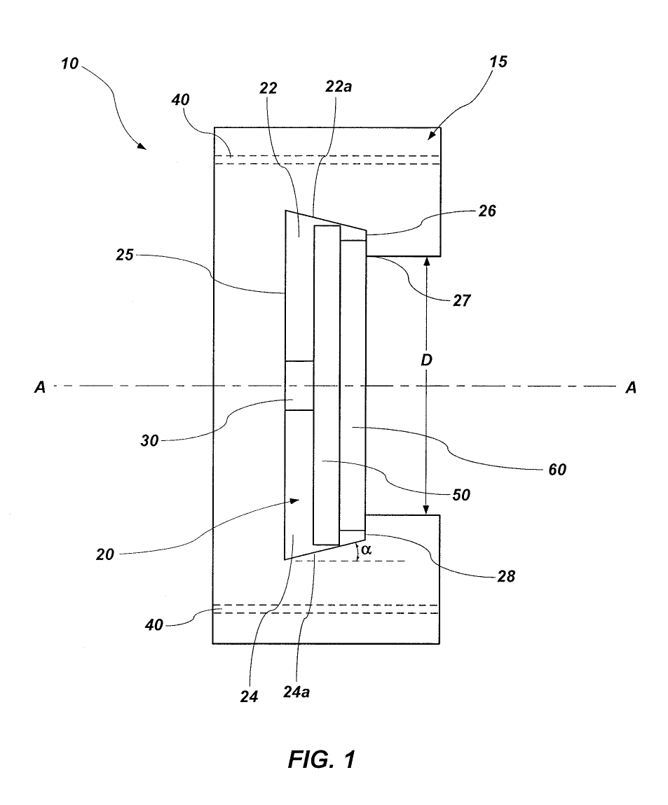

A schematic cross-section of a molding 10 with interchangeable design panels is shown in FIG. 1. The molding 10 may include a body member 15 that may be adapted to be attached to a support structure, such as, for example, a wall, ceiling, or floor. The molding 10 may be elongated and substantially linear. The body member 15 may be attached to a support structure by fastening means 40. Fastening means 40 may include nails, screws, glue, or any other fastening means to attach the body member 15 to a support structure. The body member 15 may be designed such that the body member 15 may be retrofitted with various types of interchangeable design panels 50 and/or front panels 60 after the body member 15 has been attached to a support structure.

The body member 15 may be generally symmetrical about axis A-A. Axis A-A may be substantially perpendicular to the support structure to which the molding 10 is attached. In another embodiment, the axis A-A may be angled with respect to the support structure to which the molding 10 is attached, such as in crown molding. The body member 15 may define a display cavity 20 in which interchangeable design panel 50 and front panel 60 may be installed. In one embodiment, the display cavity 20 may be defined by a trapezoidal shape and may include a top recess 22 and a bottom recess 24. The top recess 22 and the bottom recess 24 may be sized and configured to accept and retain the interchangeable design panel 50 and/or the front panel 60. Such panels may be sized to have heights adapted to fit within the space between the top recess 22 and the bottom recess 24. In one embodiment, the cross-section of the display cavity 20 may be shaped as an isosceles trapezoid. In such an embodiment, walls defining the top recess 22 and the bottom recess 24 may have substantially the same length. The top recess 22 and the bottom recess 24 may be substantially continuous and planar, as shown in FIG. 1.

The design cavity 20 may be structured to allow easy installation of the design panel 50 and the front panel 60 after the body member 15 has been attached to a support structure. The display cavity 20 may be partially defined by a top retaining ledge 26 and a bottom retaining ledge 28 to retain the design panel 50 and the front panel 60 within the display cavity 20. In some embodiments, the top retaining ledge 26 may include at least one surface that is coplanar with at least one surface of the bottom retaining ledge 28. The top retaining ledge 26 and the bottom retaining ledge 28 may include at least one surface that is substantially perpendicular to axis A-A. Each of the top retaining ledge 26 and the bottom retaining ledge 28 may include a corner 27. In one embodiment, at least one corner 27 of the top retaining ledge 26 and the bottom retaining ledge 28 may be rounded or beveled. In another embodiment, the corners 27 of the top retaining ledge 26 and the bottom retaining ledge may be substantially square, as shown in FIG. 1.

With continued reference to FIG. 1, the display cavity 20 may include an opening defined by the shortest distance between the top retaining ledge 26 and the bottom retaining ledge 28 (generally designated as dimension D). The display cavity 20 may be defined by a back wall 25, a top surface 22a, a bottom surface 24a, the top retaining ledge 26, and the bottom retaining ledge 28. In some embodiments, the back wall 25 may have a length that is larger than distance D. In other embodiments, the back wall 25 may have a length that is substantially the same as distance D. The back wall 25 may include a substantially continuous and substantially flat surface. The back wall 25 may include a surface that is substantially parallel with at least one surface of the top retaining ledge 26 and at least one surface of the bottom retaining ledge 28.

The top recess 22 and the bottom recess 24 may be designed to retain the design panel 50 and/or the front panel 60 within the display cavity 20. The top recess 22 may be defined by a top portion of the back wall 25, the top surface 22a, and the top retaining ledge 26. The bottom recess 24 may be defined by a bottom portion of the back wall 25, the bottom surface 24a, and the bottom retaining ledge 28. The top surface 22a and the bottom surface 24a may have substantially the same length. Top surface 22a and bottom surface 24a may create an angle a with axis A-A. Angle a may vary, such as for example, between approximately 10° and 20°. In one embodiment, angle a may be approximately 14°. In one embodiment, angle a between axis A-A and the top surface 22a may be substantially the same as angle a between axis A-A and the bottom surface 24a. In one embodiment, the top half of body member 15 may be a mirror image of the bottom half of the body member 15. In yet another embodiment, the angle between the top surface 22a and axis A-A may not be the same as the angle between the bottom surface 24a and axis A-A.

In one embodiment, the back wall 25 may include a plurality of snap receptacles. Thus, the back wall 25 may be configured to receive a design panel 50 with snaps to be engaged by the snap receptacles of the back wall 25. In another embodiment, the back wall 25 may include a hook-and-loop fastener (e.g., VELCRO®) or a magnetic fastener. The interchangeable design panel 50 may include a corresponding fastener. In yet another embodiment, the back wall 25 may include an adhesive material such as a removable double-sided tape material or a glue material. The adhesive material may attach the interchangeable design panel 50 to the back wall 25.

In one embodiment, a compressible material 30 may be attached to the back wall 25. The compressible material 30 may comprise a sponge-like material, a foam material, a double-sided tape material, or a weather-strip material. In one embodiment, the compressible material 30 may be a weather-strip material. In another embodiment, the compressible material may be a closed cell foam material. The compressible material 30 may be sufficiently compressible to compress along axis A-A. When the compressible material 30 is compressed, space along axis A-A within the display cavity 20 may be created for installation or removal of the design panel 50 and the front panel 60. Once the design panel 50 and the front panel 60 are installed, the compressible material 30 may expand and push the design panel 50 and the front panel 60 against the top retaining ledge 26 and the bottom retaining ledge 28. The expansion of the compressible material 30 may cause the interchangeable panels to be flush against the retaining ledges and may prevent the interchangeable panels from shifting within the display cavity 20. The compressible material 30 may have a length that is substantially less than the length of the back wall 25, as shown in FIG. 1. Thus, in some embodiments, the compressible material 30 may not abut the top surface 22a or the bottom surface 24a.

The design panel 50 may include various designs and materials. The design panel 50 may include a designed or engraved wood panel, a panel comprising a leather material, a glow in the dark material, a stained glass or plastic material, or a tile material, such as, for example, a ceramic tile or a marble tile. The design panel 50 may be substantially flat, or it may include a textured surface. The design panel 50 may include a substantially rigid material or may include a substantially flexible material. In one embodiment, the design panel 50 may have a thickness extending from the back wall 25 outwardly past the retaining ledges and beyond the front face of the body member 15. In another embodiment, the design panel 50 may have a minimal thickness, such as, for example, the thickness of paper, cloth, or wallpaper. In yet another embodiment, the design panel 50 may have a thickness of between about ⅛″ and about ⅜″. In another embodiment, the thickness of the design panel 50 may be between about ⅜″ to about ⅞″. In yet another embodiment, the thickness of the design panel 50 may be greater than ⅞″.

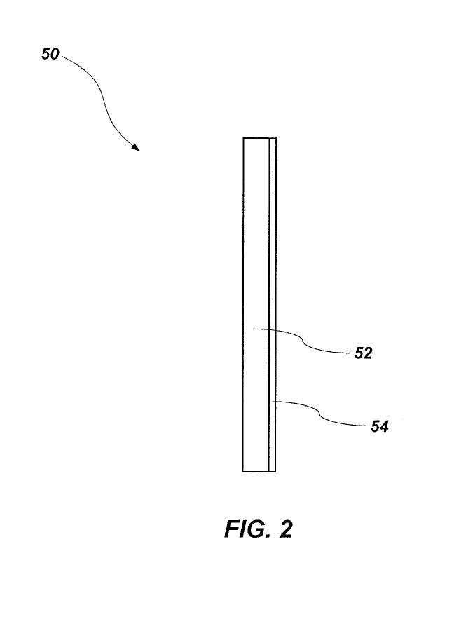

Referring to FIG. 2, the design panel 50 may include a support backing structure 52 and a design material 54. The support backing structure 52 may include a rigid material such as a rigid plastic, wood, or metal material. In one embodiment, the support backing structure 52 may include particle board, plywood, or other wood material support. In another embodiment, the support backing structure 52 may include flexible material, such as a compressible sponge-like or foam material. In one embodiment, the support backing structure may include a closed cell foam material. The design material 54 may be attached to the support backing structure 52 by any attachment means, such as, for example, glue, a thin double-sided tape, or any other suitable adhesive material. In another embodiment, the design material 54 may be stitched or sewed to the support backing structure 52.

The design material 54 may include any material, such as a wallpaper material, a leather material, a cloth material, or a glow in the dark type material attached to the support backing structure 52. Where the design material 54 is a wallpaper material, the design material 54 may be commercially available with an adhesive material on the back side thereof. In such embodiments, the design material 54 may be easily attached to the support backing structure 52.

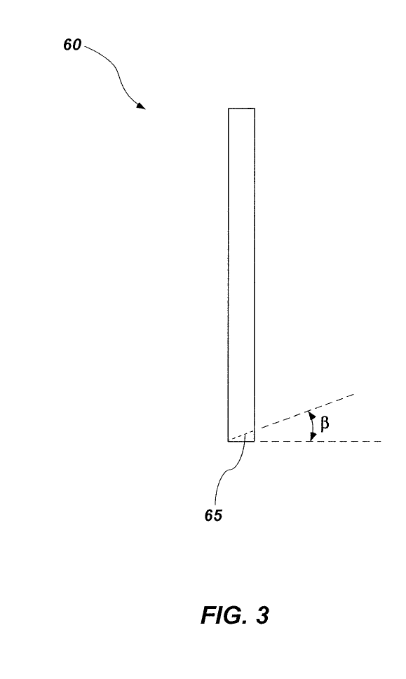

The front panel 60 may comprise a transparent material, such as, for example, a plexiglass material, a thin plastic material, or other transparent material. Referring to FIG. 3, the front panel 60 may have a tapered edge 65. In embodiments in which the front panel 60 includes a tapered edge 65, an angle β formed between the tapered edge 65 and axis A-A may be between about 10° and 20°. In one embodiment, the angle β is approximately 17°. In another embodiment, the front panel 60 may not include a tapered edge 65 and the cross-section of the front panel 60 may be substantially rectangular in shape.

In one embodiment, the design panel 50 and the front panel 60 may include a substantially rigid material. The particular design of the body member 15 with the top recess 22 and the bottom recess 24 may allow for installation and removal of the interchangeable panels without having to flex or alter the shape of the interchangeable panels upon installation or removal of such panels.

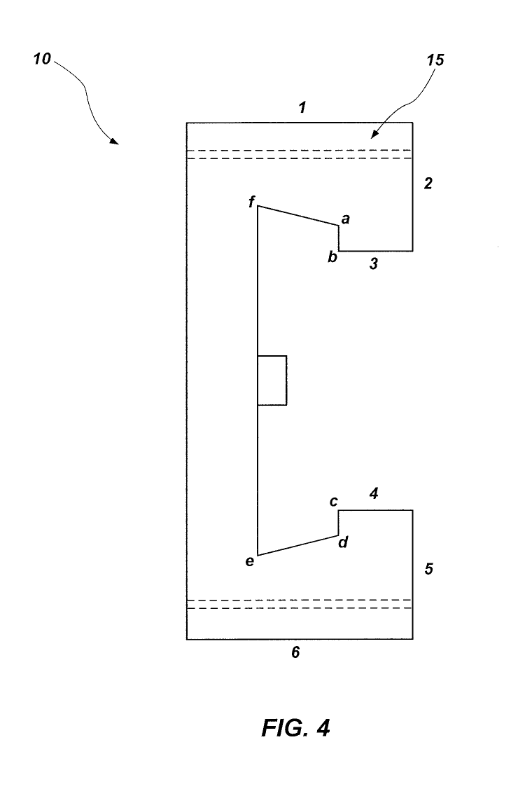

Referring to FIG. 4, the general dimensions of the body member 15 are shown. The body member 15 includes exterior surfaces 1 though 6, which may include various designs and engravings. Each of the design panel 50 and the front panel 60 may be designed with a length greater than the distance between points a and c, or the distance between points b and d. Thus, the design panel 50 and the front panel 60 may have a length that is greater than the sum of the length of at least one of the retaining ledges and the shortest distance between such ledges. In another embodiment, the design panel 50 and the front panel may have a length up to approximately the length of the distance between points f and c, or the distance between points e and b. In some embodiments, the foremost portion of either the front panel 60 or the design panel 50 abuts the retaining ledges and may not fall out from within the display cavity 20. In this manner, once the design panel 50 and the front panel 60 are installed within the display cavity 20 of the body member 15, the panels may be retained and secured within the display cavity 20 by the top retaining ledge 26 and the bottom retaining ledge 28.

The design panel 50 and the display cavity 20 may be designed such that the design panel 50 may be easily installed and removed from within the display cavity 20. The panels may be slidable within the recesses of the display cavity 20 and may be slidably installed in the body member 15. However, once the body member 15 is mounted to a supporting wall structure, the interchangeable panels may not be as easily slidably installed or removed. However, as described below, the design of the body member 15 may allow for the interchangeable design panel 50 and front panel 60 to be installed or removed after the body member 15 has been affixed to a supporting wall structure by interchanging such panels from a front face of the body member 15.

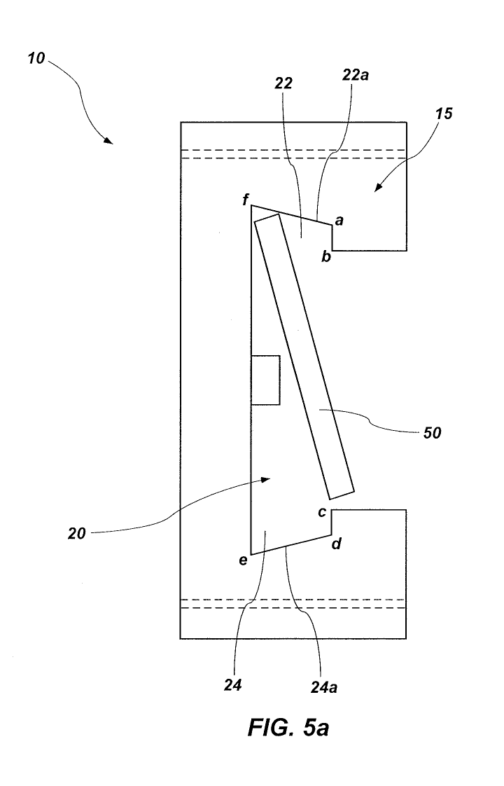

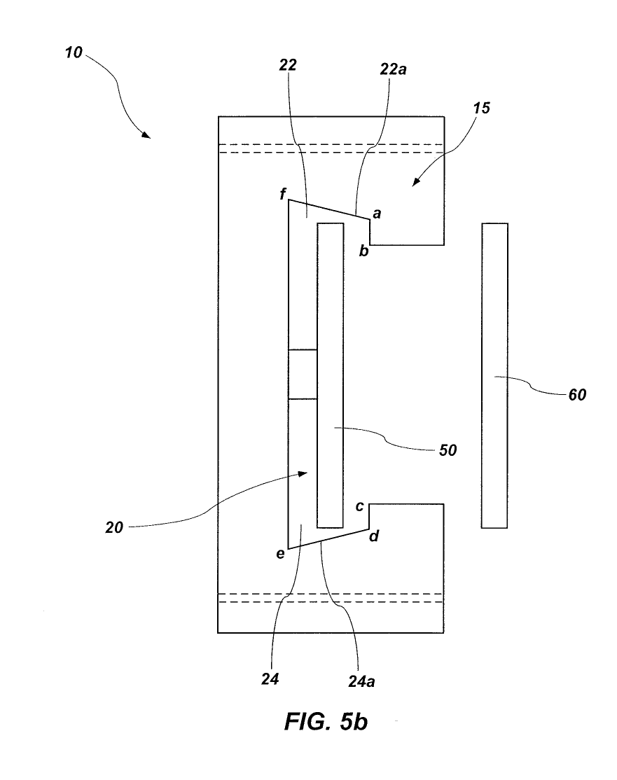

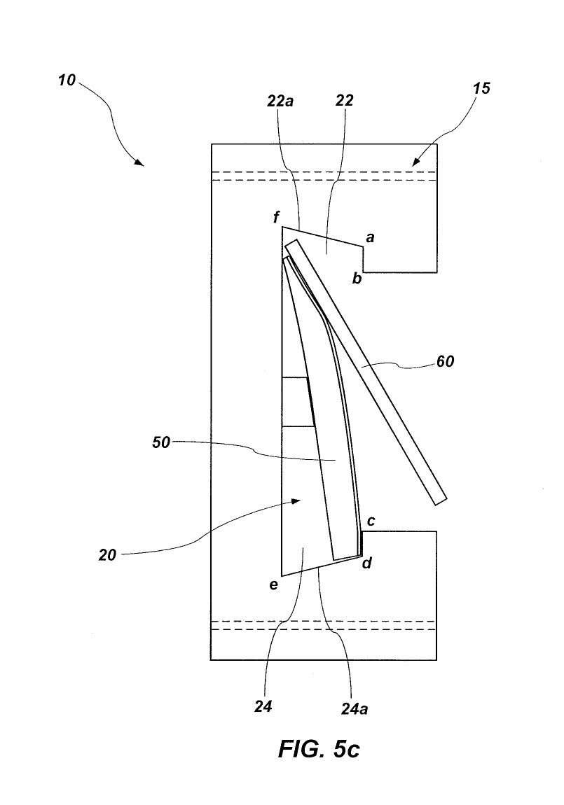

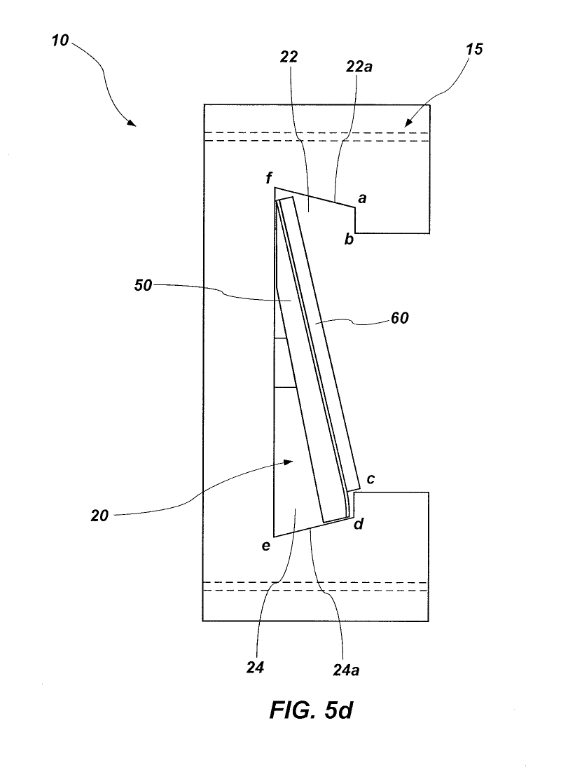

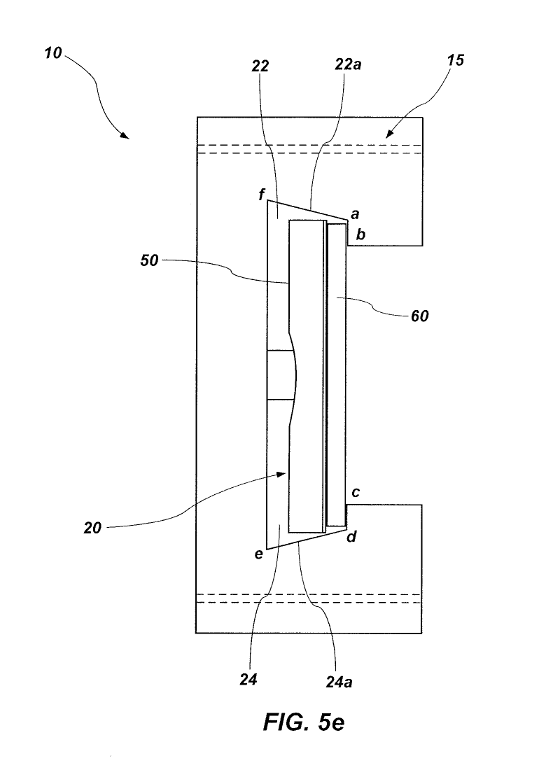

Installation of the design panel 50 and the front panel 60 is shown in FIGS. 5a through 5e. During installation of the design panel 50, a first edge of the design panel 50 may be inserted into either the top recess 22 or the bottom recess 24 and towards the back wall 25. Referring to FIG. 5a, as an edge of the design panel 50 approaches either corner for corner e of the back wall 25, enough space may be created such that the other edge of the design panel 50 may clear either corner b or corner c of the retaining ledges. Once the design panel 50 has cleared the retaining ledges of the display cavity 20, the design panel 50 may be set within the recesses of the cavity, as shown in FIG. 5b. Referring to FIG. 5c, in some embodiments, when the front panel 60 is placed into the display cavity 20, the design panel 50 may be caused to compress, creating clearance for the front panel 60 to be installed. Referring to FIG. 5d, as the front panel 60 is inserted into the display cavity 20, the compressible material 30 and the design panel 50 may be compressed towards the back wall 25 to create clearance for installation of the front panel 60. Referring to FIG. 5e, after the edges of the front panel 60 clear the retaining ledges of the display cavity 20, the front panel 60 may be disposed within the top recess 22 and the bottom recess 24. Thus, the design panel 50 and the front panel 60 may be installed without sliding such members into the body member 15 by installing such panels from a front face of the body member 15. The compressible material 30 may force the design panel 50 and the front panel 60 towards the retaining ledges and may secure such panels in place within the display cavity 20.

After the design panel 50 and the front panel 60 are installed, the compressible material 30 may expand. During installation of the panels, the compressible material 30 may be compressed to create enough clearance to install the panels within the display cavity 20. After the panels are installed, the compressible material 30 may no longer be under pressure, and the compressible material 30 may expand. The expansion of the compressible material 30 may cause the compressible material 30 to push against the back portion of the design panel 50 and may force the panel adjacent the top retaining ledge 26 and the bottom retaining ledge 28 to abut the retaining ledges. Thus, the compressible material 30 may exert a forward pressure on the design panel 50 and the front panel 60 and may cause the panels to abut the retaining ledges of the display cavity 20. In addition, the compressible material 30 may allow the interchangeable panels to remain secured in place within the body member 15 without additional members, such as retaining clips or other retaining means that may wear out or break with use.

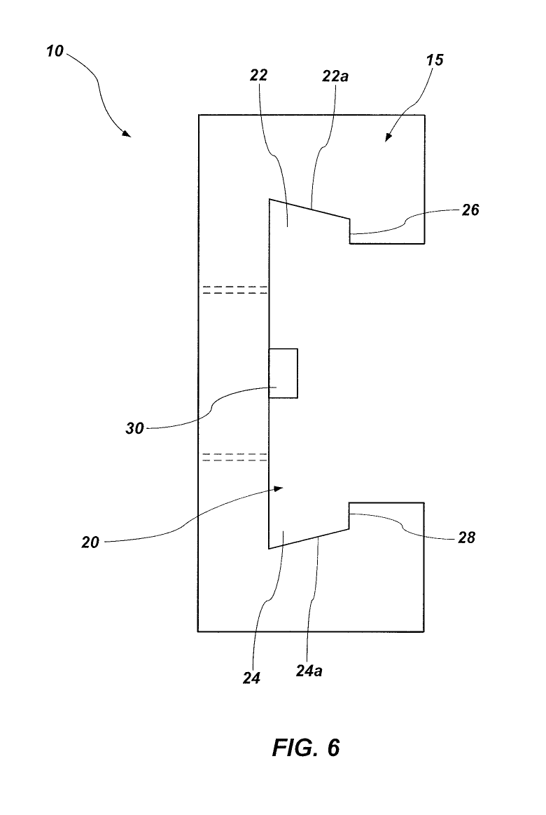

Referring to FIG. 6, the body member 15 may be designed where the top surface 22a and the bottom surface 24a are not the same length. In such an embodiment, the top retaining ledge 26 and the bottom retaining ledge 28 may have different lengths. For example, the top retaining ledge 26 may be shorter than the bottom retaining ledge 28 and the top surface 22a may be shorter than the bottom surface 24a, as depicted in FIG. 6. Alternatively, the bottom surface 24a may be longer than the top surface 22a and the bottom retaining ledge 28 may be longer than the top retaining ledge 26.

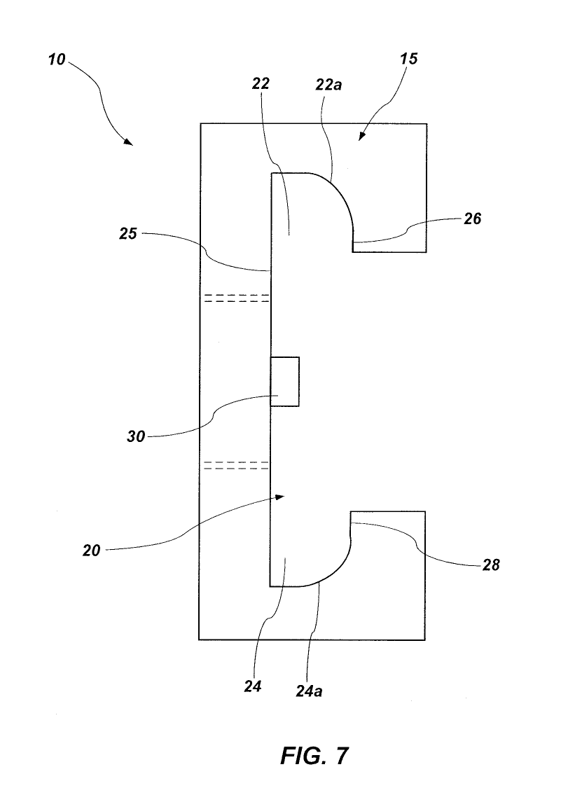

Referring to FIG. 7, in another embodiment, at least one of the top surface 22a and the bottom surface 24a may be a rounded surface. Thus, the top recess 22 may be defined by a top portion of the back wall 25, a rounded top surface 22a, and the top retaining ledge 26. The bottom recess 24 may be defined by a bottom portion of the back wall 25, a rounded bottom surface 24a, and the bottom retaining ledge 28.

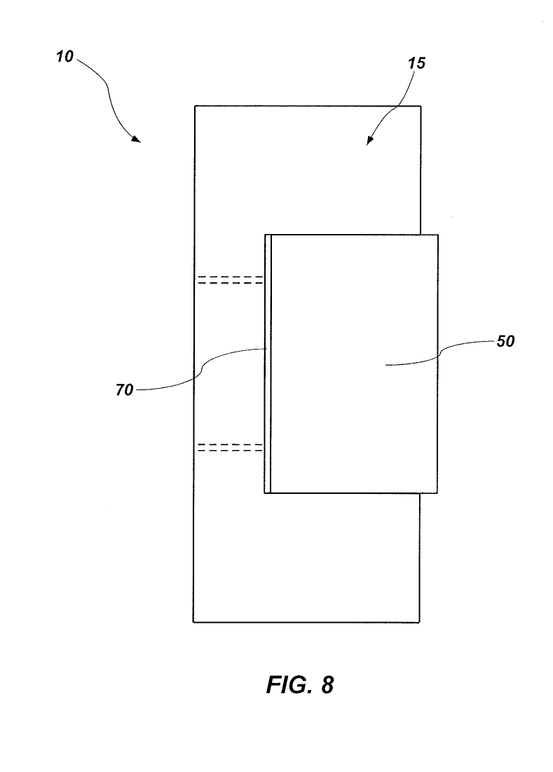

Referring to FIG. 8, the back wall 25 of the body member 15 may include an adhesive material 70 such as a double-sided tape or a glue material. In such an embodiment, the display cavity 20 may be defined by a rectangular or square shape. The design panel 50 may be secured in place by the adhesive material 70 on the back wall 25. The design panel 50 may also include the adhesive material 70 on the side adjacent the back wall 25. The adhesive material 70 may include several layers, such as when the adhesive material 70 is a double-sided tape material. In such an embodiment, the design panel 50 may extend beyond the foremost surface of the body member 15.

A molding 10 with interchangeable panels is disclosed. After the molding 10 is attached to a support structure, interchangeable panels may be interchangeably removed and installed without detaching the molding 10 from the support structure. The molding 10 may not include support clips or clamps, but may retain the interchangeable panels in place by pressing the panels against retaining ledges.

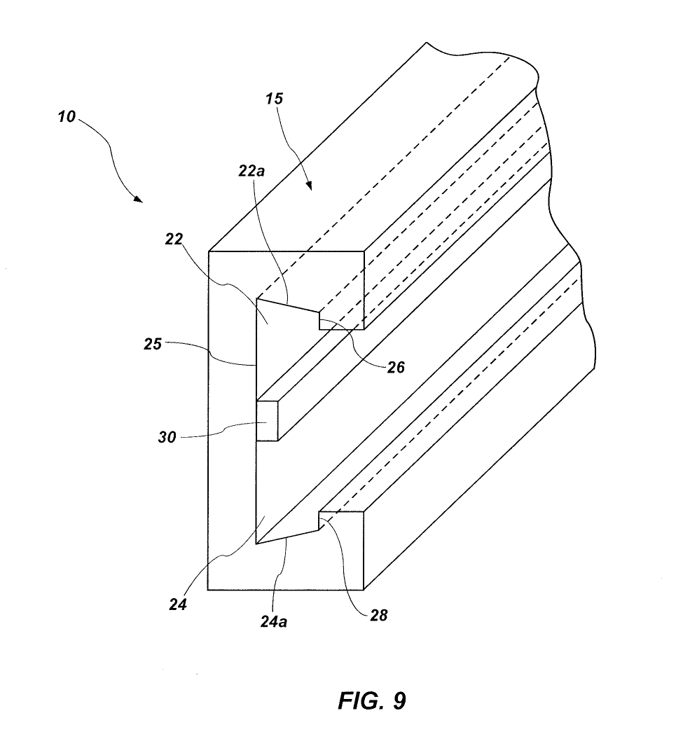

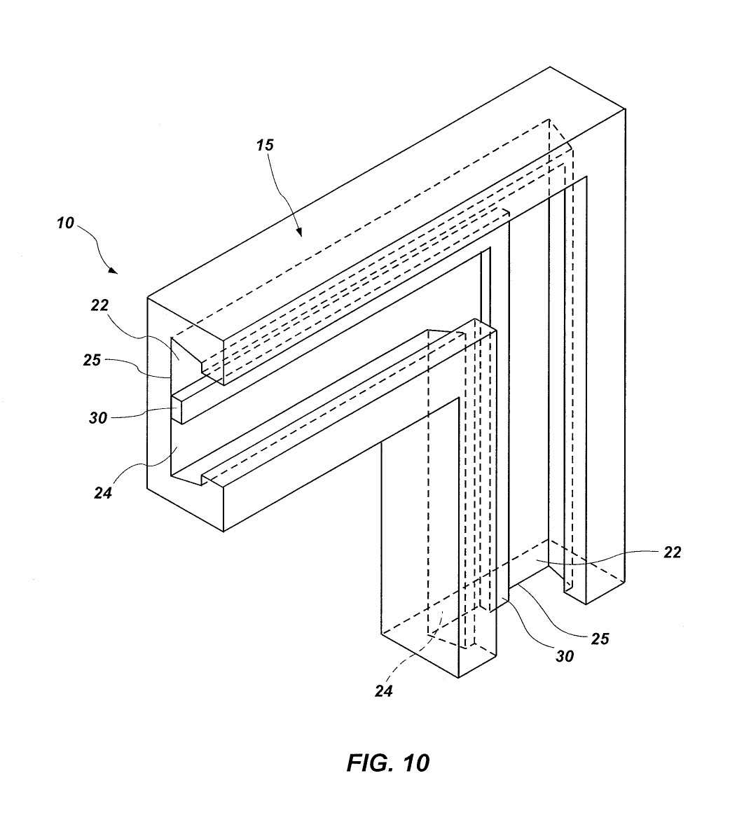

The molding 10 may be installed around various forms of intersections and corners. Referring to FIG. 9, the molding 10 may include a substantially continuous elongated member. Where pieces of molding 10 abut, the design panel 50 and/or front panel 60 may be substantially continuous and uninterrupted throughout the length of the members of molding 10 along a wall or other structure. Thus, at joints where adjacent pieces of molding 10 abut, a cap or other material may not be required to cover the intersection of adjacent pieces of molding 10 because the design panel 50 and/or the front panel 60 may be substantially continuous across several members of molding 10. By way of non-limiting example, the design panel 50 may include a continuous fabric material that may remain continuous and uninterrupted around corners of a wall and other obstructions. Thus, the design panel 50 may be substantially continuous and uninterrupted throughout the entire room in which several members of molding 10 is installed. Referring to FIG. 10, the molding 10 may form an enclosure around a room, window, or a door structure. In such an embodiment, the design panel 50 material may be substantially continuous around corners of adjacent molding 10 members, creating the appearance of a continuous molding 10 member. The design of the display cavity 20 within the body member 15 allows the design panel 50 and the front panel 60 to be interchangeably installed from the body member 15, even in embodiments where the molding 10 forms an enclosure, as shown in FIG. 10.

Although the foregoing description contains many specifics, these are not to be construed as limiting the scope of the present invention, but merely as providing certain embodiments. Similarly, other embodiments of the invention may be devised which do not depart from the scope of the present invention. For example, features described herein with reference to one embodiment also may be provided in others of the embodiments described herein. The scope of the invention is, therefore, indicated and limited only by the appended claims and their legal equivalents, rather than by the foregoing description. All additions, deletions, and modifications to the invention, as disclosed herein, which fall within the meaning and scope of the claims, are encompassed by the present invention.

What is claimed is:

1. A molding member with a removable design panel, comprising:
a body member adapted to be attached to a structure;
a display cavity within the body member, the display cavity defined by a back surface, a top surface, a bottom surface, a top retaining ledge, and a bottom retaining ledge;
a top recess defined by the top retaining ledge, the top surface, and a top portion of the back surface;
a bottom recess defined by the bottom retaining ledge, the bottom surface, and a bottom portion of the back surface;
a compressible material attached to the back surface of the display cavity; and
a removable design panel at least partially disposed between the top recess and the bottom recess within the display cavity, wherein the removable design panel is interchangeable from a front face of the body member after the body member is attached to the structure to which it is adapted to be attached to.

2. The molding member of claim 1, wherein a length of the removable design panel is greater than the sum of the length of at least one of the top retaining ledge and the bottom retaining ledge and the distance between the top retaining ledge and the bottom retaining ledge.

3. The molding member of claim 1, wherein the compressible material attached to the back surface defining the display cavity comprises at least one of a foam material, a sponge material, a weather-strip material, and a compressible double-sided tape material.

4. The molding member of claim 1, wherein the top surface and the bottom surface each form an angle of between about 10° and about 20° with a plane parallel to a central axis of the molding member.

5. The molding member of claim 1, wherein at least one of the top surface and the bottom surface each form an angle of approximately 14° with a plane parallel to a central axis of the molding member.

6. The molding member of claim 1, wherein the removable design panel comprises a design material attached to a compressible material.

7. The molding member of claim 1, wherein the top surface and the bottom surface each separately comprise a substantially planar surface.

8. The molding member of claim 1, further comprising a transparent panel disposed between the removable design panel and a surface of each of the top retaining ledge and the bottom retaining ledge.

9. The molding member of claim 1, wherein the body is substantially symmetrical about an axis that is substantially perpendicular to the structure to which the body member is adapted to be attached to.

10. A trim molding member, comprising:
a body member adapted to be attached to a structure, the body member partially enclosing a cavity, a cross-section of the cavity defined by a trapezoidal shape; and
a removable design insert at least partially disposed within the cavity, the removable design insert being interchangeable from within the cavity after the body member is attached to the structure to which the body member is adapted to be attached to.

11. The trim molding member of claim 10, wherein the trapezoidal shape that defines the cavity comprises an isosceles trapezoidal shape.

12. The trim molding member of claim 10, further comprising a compressible material attached to a back surface, the back surface partially defining the trapezoidal shaped cavity.

13. The trim molding member of claim 10, further comprising a transparent material adjacent the removable design insert.

14. The trim molding of clam 10, wherein the removable design insert comprises at least one of a tile material, a cloth material attached to a compressible material, a leather material, and a wood material.

15. A molding member with interchangeable design patterns, comprising:
a body member defining a cavity, the cavity being defined by:
a top surface;
a top retaining ledge and a bottom retaining ledge;
a bottom surface; and
a back surface; and
at least one removable panel at least partially disposed between the top surface and the bottom surface, the at least one removable panel being removable after the body member is mounted to a support structure

16. The molding member of claim 15, wherein the top surface comprises a length that is greater than a length of the bottom surface.

17. The molding member of claim 15, further comprising a compressible material attached to the back surface.

18. The molding member of claim 15, further comprising an adhesive material affixed to the back surface.

19. The molding member of claim 18, wherein adhesive material comprises at least one layer of a double-sided tape material.

20. The molding member of claim 15, further comprising an attachment means affixed to the back surface, the attachment means comprising at least one of a plurality of snap receptacles, a plurality of hook-and-loop fasteners, and a magnetic fastener.
